(19) United States
(12) Patent Application Publication
(10) Pub. No.: US 2014/0159955 A1
(43) Pub. Date: Jun. 12, 2014

(54) ADAPTIVE SIDELOBE SUPPRESSION OF RADAR TRANSMIT ANTENNA PATTERN

(71) Applicant: SRC, Inc., (US)

(72) Inventor: Harvey K. Schuman, Cazenovia, NY (US)

(73) Assignee: SRC, INC., North Syracuse, NY (US)

(21) Appl. No.: 13/712,379

(22) Filed: Dec. 12, 2012

(51) Int. Cl. G01S 7/02

(52) U.S. Cl. CPC G01S 7/023
USPC 342/367

(57) ABSTRACT

A system for adaptively generating a sidelobe null in a radar transmit antenna pattern by positioning a small air vehicle along the radial of the sidelobe to be suppressed. The air vehicle is fitted with a receiver and antenna facing the radar, as well as a GPS device for maintaining the designated position. The vehicle further includes a communication link to the processor of the main radar transmitter to form a closed loop that enables adjustment of the attenuators and phase shifters of the auxiliary channel(s) to suppress signals transmitted in the sidelobe to be nulled. The com link may be replaced by a suitable transponder.

### STATEMENT OF GOVERNMENT INTEREST

This work derives from research under Government Contract W15P7T-08-C-V004. The U.S. Government has rights in this invention.

### BACKGROUND OF THE INVENTION

1. Field of the Invention

The present invention relates to radar transmissions and, more particularly, to the suppression of sidelobe signals.

2. Description of the Related Art

Radar applications often require that the energy that is transmitted in certain directions be reduced the amount typically transmitted by the radar antenna sidelobes. One method of reducing sidelobe transmission is to simultaneously transmit a nearly equal and opposite signal through an auxiliary antenna. The amplification (or attenuation) and phase applied to the signal in the auxiliary channel, or channels, if a broad angle and/or wide band null is desired, to achieve cancelation are determined from knowledge of the complex antenna pattern of the main antenna, i.e., the amplitude and phase patterns. This process is termed “transmit nulling” and sometimes referred to as “open loop.” The achieved null depth of open loop transmit nulling is limited, however, by any errors in measuring the main antenna pattern, the auxiliary pattern, and the positioning of the main and auxiliary antennas. Furthermore, the measurements will degrade with time and the effects of the measurement environment often differ from that of the operational environment.

Another method of transmit nulling, referred to as “closed loop,” uses scattering from an opportunistic sidelobe scatterer in a feedback loop that includes the radar receiver, whereby the auxiliary channel transfer function amplitude and phase weights are adjusted until the signal is nulled to the noise level. This processing is similar to that employed in adaptive sidelobe cancellation of noise jamming, or other sidelobe interference, by which a sidelobe null is placed in the receive antenna pattern. An appropriate scatterer, however, is not always available and, in cases where one is present, it often is at too long range to yield sufficient signal strength for nulling. The radar receive antenna sidelobe is in the direction of the scatterer, as well, which further limits signal strength. For agile beam phased array antenna radars, the receive beam can be pointed toward the transmit sidelobe direction during the setting of auxiliary channel cancellation weights, and then repointed toward the targeted direction for normal operation. This increases signal strength, but usually not by enough to offset the substantial range loss that is proportional to range to the forth power.

### BRIEF SUMMARY OF THE INVENTION

The present invention comprises a method for adaptively generating a sidelobe null in a radar transmit antenna pattern. The method involves the positioning of a small air vehicle, either manned or unmanned, and typically a helicopter, along the radial from the radar that corresponds to the sidelobe to be nulled. The position of the air vehicle is generally constrained to an area that is just beyond the far field range of the transmit antenna. The air vehicle is fitted with a receiver and antenna facing the radar, as well as a GPS device for maintaining the designated position. The vehicle further includes a communication link to the platform of the main radar transmitter to form a closed loop that enables adjustment of the attenuators and phase shifters of the auxiliary channels to suppress signals transmitted in the sidelobe to be nulled. In place of the communication link, the vehicle can contain a transponder.

The method of the present invention is generally applicable to situations where a deep null must be maintained for a limited time. Because of the finite bandwidth and possible large main antenna aperture, the sidelobe response may be non-uniform throughout the bandwidth. For such cases, multiple time delay taps separated by fixed time delays with independent amplitude and phase controls can be added to the auxiliary channels. Additional auxiliary channels can be implemented, as well. However, these additional degrees-of-freedom introduced in the feedback path will increase the convergence time of the loop. Further, if only one auxiliary channel and tap is desired, the signals can be transformed to the frequency domain and divided into subbands. A distinct weight then is computed for each subband, and the nulling signals are reconstructed from their subband constituents. Finally, multiple simultaneous nulls can also be formed by using an additional air vehicle for each sidelobe to be nulled.

In the present application, a time delay tap within an auxiliary antenna path will be referred to as a “degree of freedom (DOF).” Thus, two auxiliary antennas with two taps each would comprise a four DOF system. The “main channel” refers to the radar main antenna path. In the case of subbanding, each subband per channel would be a DOF.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is a schematic of a closed loop adaptive sidelobe suppression system for a radar transmitting antenna according to the present invention.

FIG. 2 is a schematic of an embodiment of the invention for narrow band systems in which only one DOF is adequate for nulling.

FIG. 3 is a schematic of an embodiment of the invention of FIG. 2, except the communication link has been replaced by a frequency converter transponder.

FIG. 4 is a schematic of an embodiment of the invention similar to that of FIG. 1, except the Frequency Division Multiple Access (FDMA) has been replaced with a Time-Domain Multiple Access (TDMA) system for distinguishing main channel and auxiliary channel signals, and subbanding is introduced to provided additional DOFs.

### DETAILED DESCRIPTION OF THE INVENTION

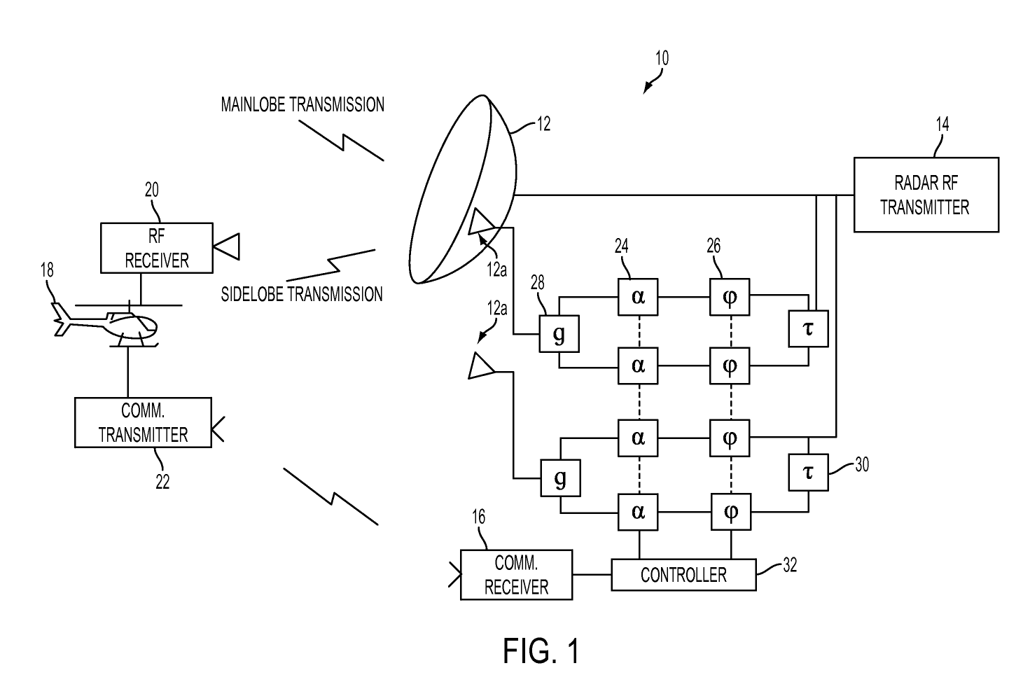

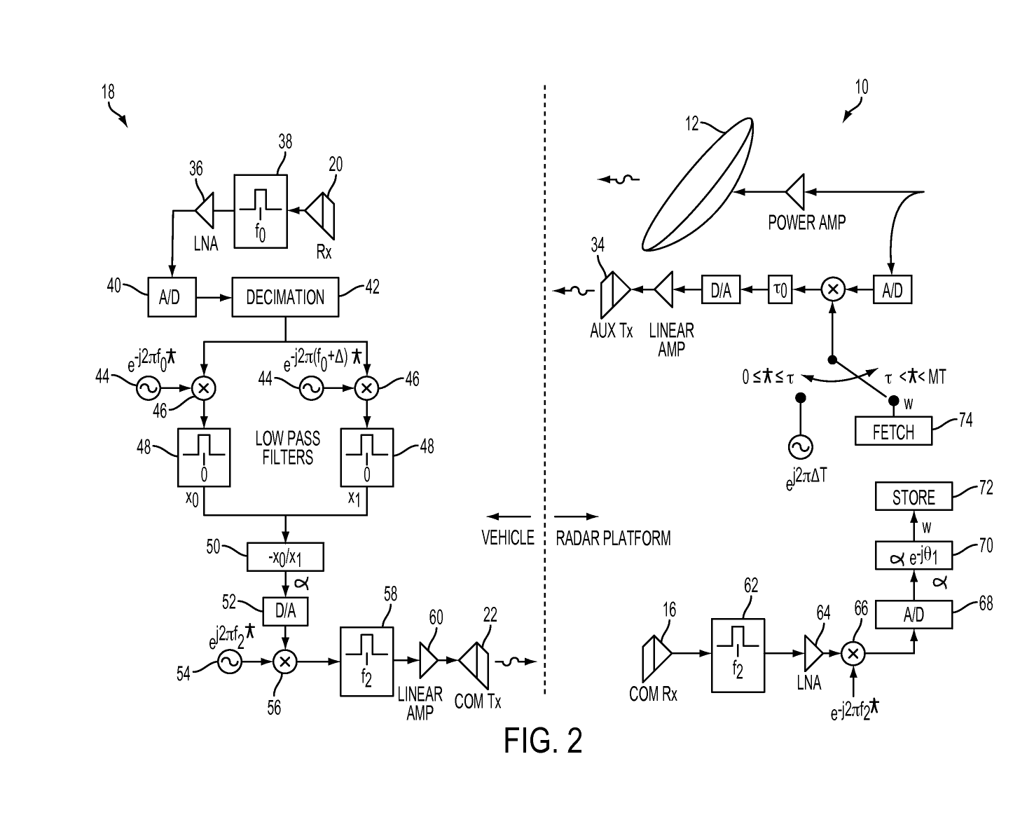

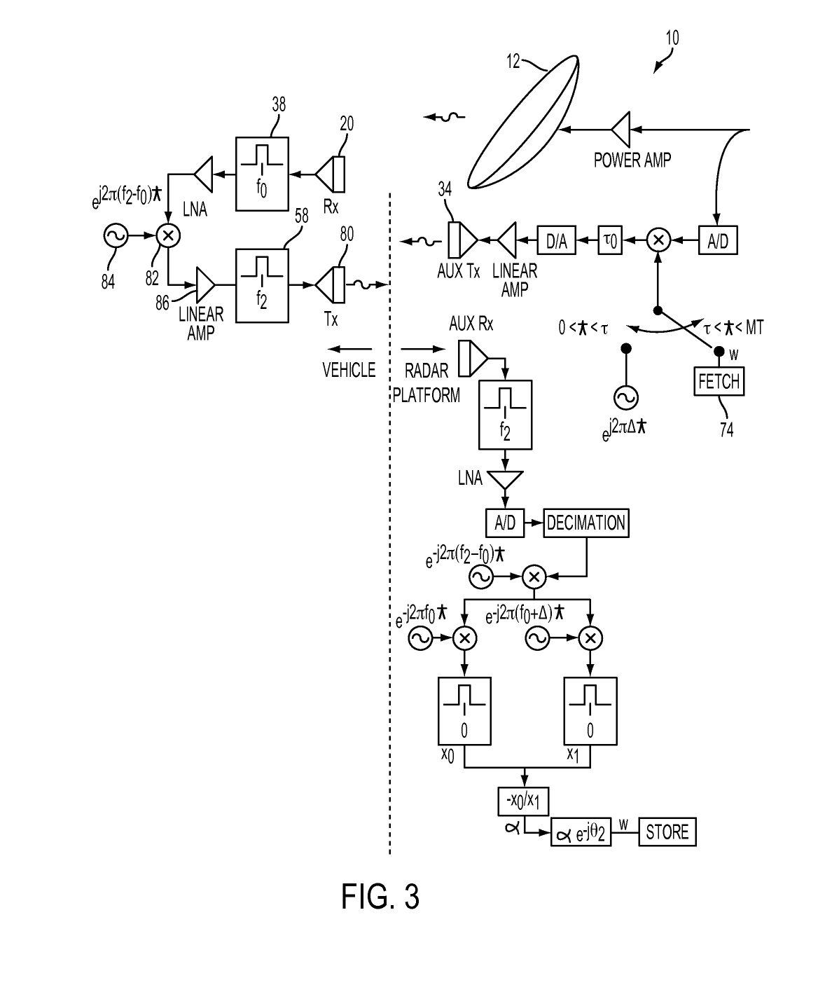

Referring now to the drawings, wherein like reference numerals refer to like parts throughout, there is seen in FIG. 1 a closed loop sidelobe transmission nulling system 10 comprising a main transmission radar 12 having a radar transmitter 14, two auxiliary transmit systems 12a, and a communication receiver 16, along with a remotely positioned aircraft or air vehicle 18 having an RF receiver 20 and a communication transmitter 22 for communicating with communication receiver 16 of auxiliary system 12a. Vehicle 18 is preferably positioned at close range to radar 12, but just beyond its far field boundary. As an alternative, communication transmitter 22 can be replaced with a transponder located on the vehicle. That replacement would shift more of the signal processing to the main radar platform, as described in more detail below and shown in FIGS. 2 and 3.

As further seen in FIG. 1, auxiliaries 12a include an electronics assembly having a plurality of variable attenuators 24, phase shifters 26, fixed gain amplifiers 28, and fixed delays 30, where the variable attenuators 24 and phase shifters 26 are operably connected to communication receiver 16 via a controller 32. For simplicity, only two auxiliary channels with two time taps are depicted in FIG. 1, but those of skill in the art will recognize that the numbers of auxiliaries and time taps will depend on the particular system and desired null depth.

Thus, system 10 forms a closed feedback loop that allows controller 32 to adjust attenuators 24 and phase shifters 26 of the auxiliary channels to suppress signals transmitted in the sidelobe and thus null the signals based on information received from communication transmitter 22 of vehicle 18 about signals received by RF receiver 20 of vehicle 18. This closed loop approach according to the present invention allows for adjustment of the auxiliary channel transfer function amplitude and phase “weights” based on signals received from the air vehicle until the superposition of the signals (auxiliary and main) is nulled to the noise level.

The method of the present invention is generally applicable to situations where a deep null must be maintained for a limited time. Because of the finite bandwidth and possible large main antenna aperture, the sidelobe response may be non-uniform throughout the bandwidth. For such cases, multiple time delay taps separated by fixed time delays 30 with independent amplitude and phase controls can be added to the auxiliary channels. The taps, if needed, should be spaced approximately c/2 BW apart, where c denotes the speed of light and BW the signal bandwidth. The entire span of the taps should exceed the maximum expected multipath delay spread of the main channel signal transmitted from the radar.

Additional auxiliary channels can also be implemented, and these additional degrees-of-freedom introduced in the feedback path will increase the convergence time of the loop (or “latency,” as discussed below). Multiple simultaneous nulls can also be formed by using an additional air vehicle for each sidelobe to be nulled.

The present invention requires that the signals transmitted through the taps and auxiliary antennas be distinguished at the vehicle, and that the vehicle antenna has not moved a significant part of a wavelength in the direction of the radar during collection of the data needed to form a pattern null. The aux and main channel transmissions can be separated in time (TDMA), in frequency (FDMA), or by coding (CDMA). For an FDMA implementation the main and auxiliary signals are sampled simultaneously. For example, a 1 GHz radar with 1 MHz bandwidth requires only one DOF and only one sample each of the main and of the auxiliary channel. The 1 MHz bandwidth implies 1 μs is sample time. For 20 dB nulling (that is, 20 dB below the quiescent sidelobe level), the vehicle antenna down range movement must not exceed 3 mm in 1 μs. This implies that the vehicle down range velocity not exceed 3 km/s or 6700 mi/hr. Perhaps more pertinently, platform vibrations must not exceed this rate. In the example of a helicopter comprising the vehicle 18, the rotor rate is typically 450 RPM. For a (huge) peak to peak antenna vibration of 1 m, the movement is less than 1 m in 0.5 rev or 15 m/s, well below 3 km/s.

The solution for the weights from the data samples may be determined as follows. Let w denote the column vector of complex weights, x the column vector of complex samples (measured at the vehicle) of the signals transmitted through all but the main channel, x₀ the sample of the main channel signal, and superscript H conjugate transpose. The data x and x₀ are functions of time. These data can be sampled at multiple time points separated by 1/bandwidth over an interval of time (“time sampling interval”). The weight vector satisfies the formula:

Minimize E{|w^{H}x−x₀|²}

where E{ } denotes expectation.

The solution is found by setting the partial derivatives, with respect to the elements of w^{H} to zero, holding the elements of w constant, and solving the resulting equations for w. The same w results if the process were repeated by partial differentiating with respect to the elements of w and solving for w^{H}. The solution is given by

w=E{xx^{H}}⁻¹E{xx₀*} where * denotes conjugate.

The expectations generally would be estimated by averaging the respective data over the time sampling interval. The longer the interval, the more accurate the solution but the longer the latency, which is the time required to determine and apply the nulling weights. Some systems may require that the nulling weights be determined quickly. Fortunately, because the range of the vehicle from the radar is relatively short and the vehicle can be fitted with antennas containing 10 or 15 dB gain, the signals received by the vehicle and applied in determining the nulling weights will be strong, i.e., well above system noise. The large signal to noise ratio (SNR) will reduce the averaging time. Further, the radar bandwidth is often narrow and multipath delay spread small. In such cases, effective nulling may be performed with only one DOF, further reducing averaging time.

There is seen in FIGS. 2 through 4 embodiments for implementing the present invention for the narrow band radar and high SNR case whereby only one DOF is needed. FIG. 2 pertains to a FDMA system with a dedicated wideband synchronous communication link between the radar and vehicle platforms. In particular, FIG. 2 shows the principal equipment elements for use in a FDMA system for distinguishing main channel signal from main transmitter 12 and auxiliary channel signals transmitted from auxiliary transmitter 34. This implementation employs a synchronous communication link between vehicle and radar platforms using communication transmitter 22 of vehicle 18 and communication receiver 16. In particular, vehicle 18 includes a low noise amplifier 36 connected to RF receiver 20 via a filter 38 centered at the radar transmission frequency. The output of low noise amplifier 36 is A/D sampled 40, decimated 42, and then, in parallel channels, combined with input signals from oscillators 44 using mixers 46, low pass filtered 48 to separate the main channel signal (x₀) and the aux signal (x₁), and then divided and negated 50 to obtain the factor (α) needed for cancellation. The auxiliary signal information is converted back to analog by D/A convertor 52, added to a carrier signal from an oscillator 54 using a mixer 56, filtered using a filter 58 at the desired communication transmission frequency, and then amplified by an amplifier 60 for transmission to main transmission radar via communication transmitter 22.

Transmissions from communication transmitter 22 are received by communication transmitter 16, filtered at the communication carrier frequency, f₂, using a bandpass filter 62, amplified by a low noise amplifier 64, mixed with an oscillator 66, and then A/D sampled 68. The digitally sampled signal is then processed to determine the appropriate nulling weight 70, which may be stored 72 for later use 74. Note that the weight, w, is given by α=−x₀/x₁ times a correction phase shift needed to account for the propagation phase delay [θ₁ denotes the correction phase, =2πΔp where Δ denotes the aux transmission offset frequency and p denotes the propagation delay between radar platform and vehicle. θ₁ can be determined by transmitting a low level signal exp(j2πf₀t)+exp(j2π(f₀+Δ)t) through the aux channel and recording the phase of α. This can be done during any unused part of the pulse repetition interval (T) and updated as needed. Note that Δp is likely to be small so that the correction, if needed at all, need only be estimated.] Thus w, when multiplied (via mixing) with the aux signal, results in the aux channel transmitting the negative of the main channel signal. This, in turn, results in sidelobe signal cancellation in the direction of the vehicle.

Also in FIG. 2, time t=0 indicates the time at the beginning of the transmission of the pulse, τ₀ denotes the time delay applied in matching the aux and main channels, τ denotes the latency, f₂ denotes the communication link frequency, and M denotes the number of pulses transmitted before requiring weight updating.

FIG. 3 illustrates the use of a FDMA system as part of a sidelobe transmission nulling system 10 with a frequency converter transponder 80 in place of communication transmitter 22. Thus, processing at vehicle 18 is limited to receipt of signals via receiver 20, filtering with filter 38 at the radar frequency, mixing 82 with a local oscillator signal 84, amplifying by an amplifier 86, filtering at the offset carrier frequency by filter 58 and transmitted back to the main transmission radar 12 platform using transponder antenna 80. As a result, the signal processing implemented at vehicle 18 will instead be performed at main transmission radar 12 platform, i.e., the return signal will be processed as explained above to obtain the auxiliary signal information and then perform the appropriate weight computations and determine the nulling weights.

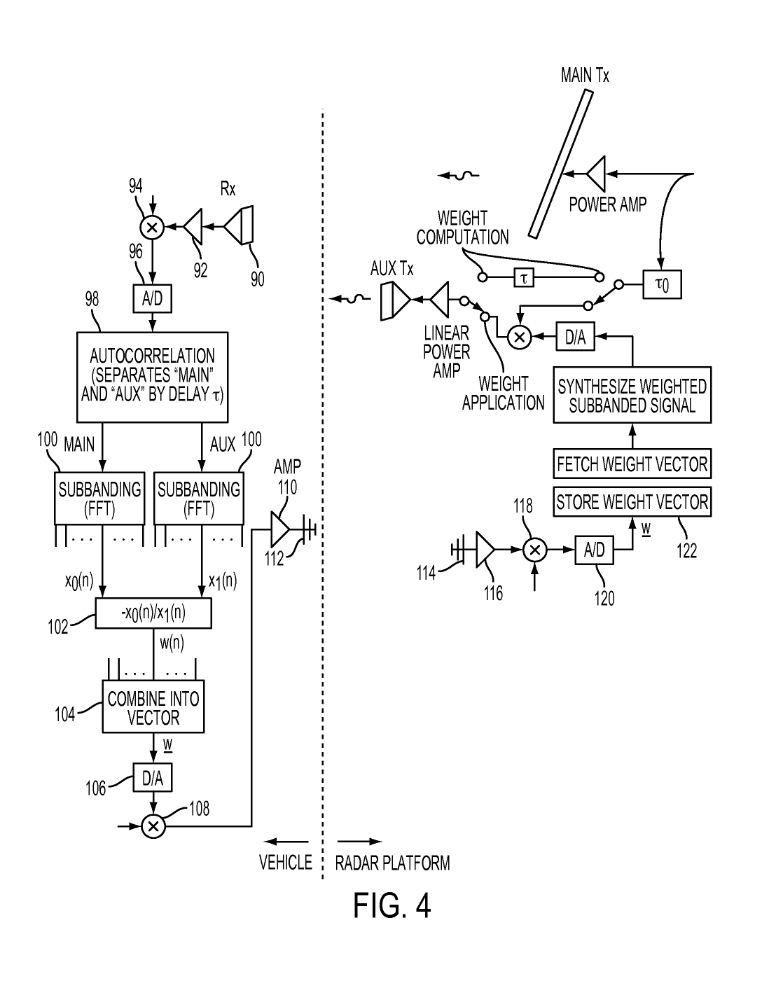

Finally, FIG. 4 illustrates the use of a TDMA system as part of sidelobe transmission nulling system 10 with dedicated wideband synchronous communication link and subbanding. In this case, vehicle 18 is outfitted with receiver antenna 90 that receives radar signals, amplifies with an amplifier 92, combines the amplified signals with a local oscillator using a mixer 94, and then converts to digital using an A/D converter 96. The converted signal may then be autocorrelated 98 to separate the main and auxiliary signals based on delay (τ) applied in auxiliary channel. The main and auxiliary signals may then be processed in the frequency domain in parallel using Fast Fourier Transforms 100 to determine the main and auxiliary signal information, then frequency divided 102 to determine weighting functions, and then combined into the a weight vector 104. The weight vector can then be converted into analog by a D/A converter 106 and added to a carrier signal 108, amplified 110 and then transmitted to main transmission radar 12 using communication link antenna 112. A corresponding communication link antenna 114 at main transmission radar 12 platform can then receive the transmitted signal that is then amplified with an amplifier 116, combined with a local oscillator using a mixer 118, converted to digital using a digital converter 120 to extract the weight vector, which can then be stored 122 for use.

What is claimed is:

1. A radar transmit antenna sidelobe suppression system, comprising:
a radiofrequency antenna for sending a sidelobe signal in a predetermined radial direction;
a vehicle positioned remotely from said antenna in said radial direction of said sidelobe signal, wherein said vehicle includes a radiofrequency receiver for receiving information about said sidelobe signal and a communicator interconnected to the radiofrequency receiver to transmit said information about the sidelobe signal;
an auxiliary receiver associated with said antenna for receiving said sidelobe signal and having an auxiliary channel including a variable attenuator and a phase shifter;
a communication receiver associated with said radiofrequency antenna for receiving said information about the sidelobe signal transmitted from said vehicle;
a controller interconnected to the variable attenuator and the phase shifter for adjustment of the variable attenuator and the phase shifter to suppress said sidelobe signal based on said information about said sidelobe signal received from said vehicle.

2. The system of claim 1, wherein said vehicle includes a global positioning system for maintaining its position in said radial direction of said sidelobe signal.

3. The system of claim 2, wherein said vehicle is positioned just beyond a far field boundary of said antenna.

4. The system of claim 1, wherein said controller is programmed to vary a transfer function and a phase weight until the sidelobe signal is nulled to the noise level.

5. A method of suppressing a radar transmit antenna sidelobe, comprising the steps of:
sending a sidelobe signal from a radiofrequency antenna in a predetermined radial direction;
receiving said sidelobe signal with an auxiliary channel of said antenna;
positioned a vehicle remotely from said antenna in said radial direction of said sidelobe signal;
receiving said sidelobe signal using a radiofrequency receiver associated with said vehicle;
transmitting information about said sidelobe signal from said vehicle to said radiofrequency antenna and;
adjusting said sidelobe signal received by said antenna based on the information about said sidelobe signal transmitted from said vehicle.

6. The method of claim 5, wherein the step of adjusting said sidelobe signal comprises the step of providing a controller interconnected to said auxiliary channel.

7. The method of claim 6, wherein the step of adjusting said sidelobe signal further comprises using said controller to adjust a variable attenuator and a phase shifter associated with said auxiliary channel.

8. The method of claim 5, wherein the step of positioning a vehicle remotely from said radiofrequency antenna in said radial direction of said sidelobe signal further comprises positioning said vehicle just beyond a far field boundary of said antenna.
